(19) United States
(12) Patent Application Publication
(10) Pub. No.: US 2002/0054614 A1
(43) Pub. Date: May 9, 2002

(54) Wavelength discretely tunable semiconductor laser

(76) Inventor: Hong Jin, Santa Rosa, CA (US)

Correspondence Address: LEONARD TACHNER, A PROFESSIONAL LAW CORPORATION, 17961 SKY PARK CIRCLE, SUITE 38-E, IRVINE, CA, 92614-6364, US

(21) Appl. No.: 10/016,523

(22) Filed: Oct. 30, 2001

Related U.S. Application Data
(60) Provisional application No. 60/246,363, filed on Nov. 7, 2000.

(51) Int. Cl. H01S 3/10; H01S 3/08

(52) U.S. Cl. 372/20; 372/92

(57) ABSTRACT

A wavelength discretely tunable semiconductor laser that addresses wide wavelength tuning range, is mode hopping free, has high output power, has fast wavelength switching time, is wavelength locking free and is relatively simple. Four exemplary embodiments disclosed herein utilize a wavelength discretely tunable semiconductor laser that comprises a discretely tunable filter and laser amplifier. In the first embodiment, the tuning element comprises a pair of cascade Fabry-Perot filters, each having a plurality of characteristic narrow transmission passbands that pass only the cavity mode under the passband. The spacing between the narrow transmission passbands are slightly different in one filter from the other filter so that only one passband from each filter can be overlapped in any given condition over the entire active element gain spectral range, thereby permitting lasing only at a single cavity mode passed by the cascade double filters. One of the two etalon filters can be made with a plurality of transmission passbands predetermined by industry, application and international standards, making this element an intra-cavity wavelength reference and eliminating further wavelength locking needs for the tunable laser. In a second embodiment, one of the two etalons is replaced by a wedge filter. The filter optical path change and thus the transmission passband shift are achieved by translating the wedge filter in a direction perpendicular to the optical axis. In a third embodiment, one of the two etalon filters is replaced by a polarization interference filter. The polarization interference filter consists of an electro-optically-tunable birefringent waveplate, a fixed birefringent waveplate, the laser cavity and T.E. polarization light emitted from the laser diode. In a fourth embodiment, the laser and wavelength tuning structure are integrated on a semiconductor substrate by epitaxy processes.

### CROSS-REFERENCE TO RELATED APPLICATIONS

This application takes priority from Provisional Patent Application Ser. No. 60/246,363 filed Nov. 7, 2000.

### BACKGROUND OF THE INVENTION

1. Field of the Invention

This invention relates to semiconductor lasers, and in particular to an apparatus to provide rapid, selective and discrete wavelength tunability over a broadband wavelength spectrum. More specifically, the present invention comprises a semiconductor diode laser system that can be operated at discretely variable optical frequencies and can be tuned rapidly to a random or pre-selected frequency covering a broadband wavelength range by employing a variety of intra-cavity etalon filters.

2. Background Art

Tunable lasers are of great importance in many applications in optical communications. While continuous tunability is required in some applications, a discrete and selective wavelength tuning and switching is very desirable in many applications. For example, dense wavelength domain multiplexing in optical communication networks is defined at standard 100-GHz (˜0.8 nm at 1550 nm) spacing by the International Telecommunication Union (ITU). In this application, optical sources providing optical carriers must operate at precise and discrete wavelengths with 100-GHz spacing across the entire optical fiber transmission window. A tunable laser with the capability to discretely tune and switch wavelength over a broad wavelength range, replaces multiple single dedicated wavelength lasers.

Various techniques are known in the art for discrete wavelength tuning in tunable lasers. For example, U.S. Pat. No. 5.699,378 to Lealman et al describes an optical comb filter formed by two gratings having a multiple peak optical passband spaced apart in the active region of an optical gain element. The comb filter requires combining with a waveguide vertically-coupled filter to provide a device that is widely tunable over specific wavelengths. U.S. Pat. No. 4,896,325 to Coldren et al describes a multi-section tunable laser with differing multi-element mirrors. Mirrors are made with narrow, spaced reflective maxima in which the maxima spacing is different in one mirror from that of the other, and are bounding the active gain element to form a laser cavity. In both of the above patent disclosures, the tunability is restrained by the laser output power. Furthermore, accurate wavelength setting and calibration is very complicated owing to a plurality of interdependent control elements and lack of wavelength references built in the laser. Because the dimension of the integrated sampled grating is small, the discrete passbands, or maxima, are well separated. Thus, the offset maxima from each grating must be simultaneously adjusted in order to cover every wavelength. This will require external wavelength locking to provide wavelength reference at each wavelength.

In U.S. Pat. No. 4,897,843 to Scott, U.S. Pat. No. 5,121,399 to Sorel et al and U.S. Pat. No. 4,727,552 to Porte et al, birefringent crystal materials are required in the laser cavity, together with linear polarizers and the laser cavity to form a polarization interference filter. The tuning is achieved by discrete cavity mode hopping and is controlled by electro-optically modulating the birefringent filter. In this type of configuration, the tuning range is limited within less than 10 nm because of the nature of the filter and mode-hopping. The filter bandwidth is further limited by the number of round-trips of light in the cavity. Thus, the spectral selectivity depends on pump current and the gain of the active media. In addition, the crystal must be critically aligned to exhibit the birefringent effect.

Another approach is the use of a laser with a grating-assisted vertically-coupled filter (GAVCF). The paper by Kim I. Et al, “Broadly Tunable Vertical-Coupler Filtered Tensile-Strained InGaAs/lnGaAsP Multiple Quantum Well Laser”, Appl. Phys. Lett. 1994, 64, (21), pp 2764-2766, disclosed one such device. Although a total tuning range of 70 nm is claimed, and only one control current is required, the device is not able to cover all wavelengths but instead, hops between longitudinal modes of the laser cavity.

Rapid electro-optical tuning has been reported in the following articles. Heismann et al, “Narrow-Linewidth, Electro-Optically Tunable InGaAsP-Ti:LiNbO3 Extended Cavity Laser”, Appl. Phys. Lett. 1987, 51 (3), pp 164-166 and Schremer et al, “Single-Cavity Tunable External Cavity Laser Using An Electro-Optical Birefringent Modulator”, Appl. Phys. Lett. 1989, 55 (1), pp 19-21 and Wacogne et al, “Wavelength Tuning Of A Semiconductor Laser Using Nematic Liquid Crystal”, J. Of Quantum Electronics, 1993, 29, (4), pp 1015-1017 and Wacogne et al, “Single Lithium Niobate Crystal For Mode Selection And Phase Modulation In A Tunable Extended-Cavity Laser Diode”, Optics Lett. 1994, 19 (17), pp 1334-1336. All known prior reported electro-optical tunable lasers rely on electro-optic birefringent effects. While the tuning speed can reach nanosecond order, tuning range is commonly limited within 10 nm and discrete wavelength tuning cannot be accurately controlled and relies entirely on mode-hopping which is detrimental in optical communication networks and undesirable in many other applications.

### SUMMARY OF THE INVENTION

The present invention provides a wavelength discretely tunable semiconductor laser that addresses wide wavelength tuning range, is mode hopping free, has high output power, has fast wavelength switching time, is wavelength locking free and is relatively simple.

One object of the present invention is to provide a tunable laser capable of discrete wavelength selection and switching over any specified wavelengths in a broad spectrum range.

Another object of the present invention is to provide an integrated intra-cavity wavelength reference mechanism that is compliant with industry, application and international standards.

Still another object of the present invention is to provide a means of discrete wavelength tuning by incorporating intra-cavity two-etalon filters with laser structures.

Yet another object of the present invention is to provide electro-optical, thermal-mechanical and electromechanical means to tune wavelength discretely.

Four exemplary embodiments disclosed herein utilize a wavelength discretely tunable semiconductor laser that comprises a discretely tunable filter and laser amplifier. In the first embodiment, the tuning element comprises a pair of cascade Fabry-Perot filters, each having a plurality of characteristic narrow transmission passbands. The spacing between the narrow transmission passbands are slightly different in one filter from the other filter so that only one passband from each filter can be overlapped in any given condition over the entire active element gain spectral range, thereby permitting lasing only at a single cavity mode passed by the cascade double filters. One of the two etalon filters can be made with a plurality of transmission passbands predetermined by industry, application and international standards, making this element an intra-cavity wavelength reference and eliminating further wavelength locking needs for the tunable laser.

In a second embodiment, the tuning element retains the above discussed features while allowing translational tuning, as opposed to other tuning means in other embodiments, by employing a wedge shape filter in the cascade filter combination. In this embodiment, one of the two etalons is replaced by a wedge filter. The filter optical path change and thus the transmission passband shift are achieved by translating the wedge filter in a direction perpendicular to the optical axis. When the wedge filter is translated, the cross section of optical axis and wedge filter is varied, thus the optical path in the filter is changed.

In a third embodiment, one of the two etalon filters is replaced by a polarization interference filter. The polarization interference filter consists of an electro-optically-tunable birefringent waveplate, a fixed birefringent waveplate, the laser cavity and T. E. polarization light emitted from the laser diode.

In a fourth embodiment, the laser and wavelength tuning structure are integrated on a semiconductor substrate by epitaxy processes while retaining all of the features discussed in previous embodiments.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 is a schematic of a first embodiment of the wavelength discrete tunable laser according to the present invention;

FIG. 2, comprising FIG. 2a and FIG. 2b, shows characteristic frequency responses of each Fabry-Perot etalon filter as well as the combined or cascade filters of the first embodiment;

FIG. 3 shows the tuning and lasing mechanism in the current invention;

In FIG. 4, comprising FIG. 4a and FIG. 4b, is a graph of the transmission passband from each Fabry-Perot filter relatively shifted by optical path changes in one or both filters;

FIG. 5 demonstrates the experimental performance of the present invention; from a packaged tunable laser device built with the present invention showing more than 40 discretely lasing wavelengths separated at ITU standard of 100 GHz.;

FIG. 6 shows a second embodiment of the tuning element which employs a wedge-shaped filter in the cascade filter combination;

FIG. 7 shows a third embodiment of the inventive tuning structure; and

FIG. 8 shows a fourth embodiment of the invention.

### DETAILED DESCRIPTION OF PREFERRED EMBODIMENTS

The wavelength discrete tunable laser of the current invention provides the advantages of a small form factor, precise and fast emitting wavelength tuning, wavelength drift free with built-in wavelength grid standard, self-locking and calibration and high output power.

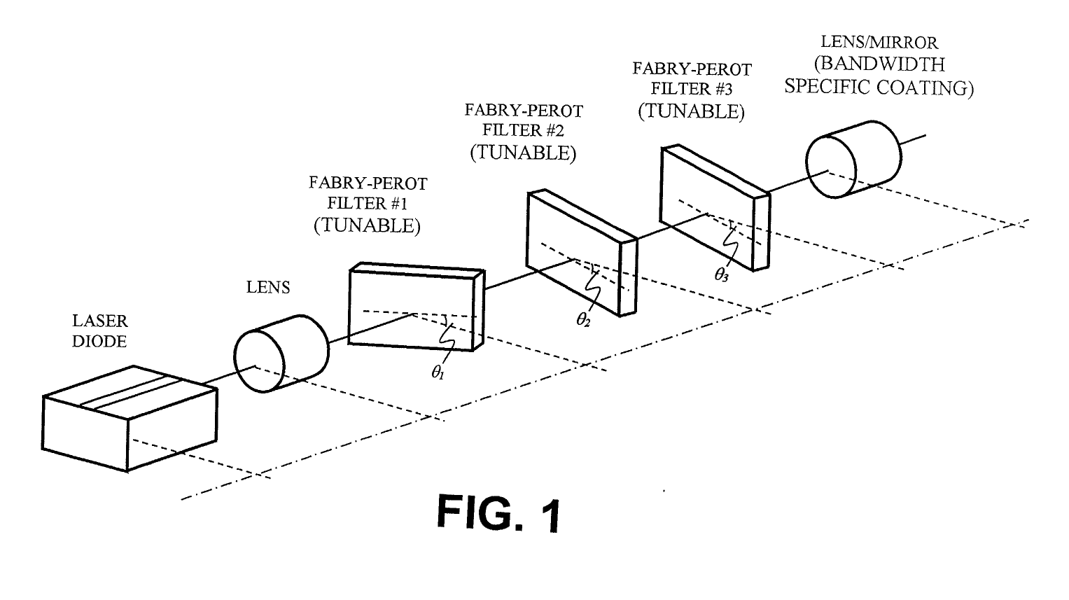

FIGS. 1 and 6 through 8 illustrate several embodiments of the current invention. The optical components of all of these embodiments are laid out along an optical axis.

FIGS. 1 is a schematic of a first embodiment of the wavelength discrete tunable laser according to the present invention. The first embodiment comprises a semiconductor laser diode having a spontaneous emission centered around a pre-selected wavelength range and having anti-reflection coating on one facet facing the cavity and an uncoated facet facing the outside of the cavity; a collimating lens; two etalon filters No. 1 and No. 2 as tuning elements, a third etalon filter No. 3 and a GRIN lens with high reflection coating on the back side. The laser cavity is bounded by the uncoated facet of the laser diode and the back surface of the GRIN lens.

The semiconductor laser diode can be made of GaAs,/AlGaAs, or InP/lnGaAsP, or the like, emitting light with center wavelength at 850 nm, 1330 nm, 1550 nm or any wavelength of interest. Different laser chips with a variety of optical luminescent intensities can be employed, each being capable of operation at sufficiently high power for practical purposes. The angled-strip diode structure together with the anti-reflection coating on the facet facing the cavity, radically minimizes the residual Fabry-Perot modes affecting the extended cavity operations.

The tuning element is a filter combination consisting of two intra-cavity cascade Fabry-Perot etalon filters. The first filter cavity is made to have a cavity length, kL, and the second filter cavity made to have a length, mL, where the L is a common length factor. The factors of k and m are selected to differ slightly from one to the other. As a result, the free spectral range (FSR) value, FSR1=c/(2nkL) for the first filter and FSR2=c/(2nmL) for the second filter, are slightly different, where c represents the velocity of light and n is nominal refractive index of the filter material. The equivalent FSR of the cascade filter is (FSR1×FSR2)/(FSR1-FSR2), thereby resulting in a much larger equivalent FSR than either individual filter.

The third etalon filter can be coated with anti-reflection coating and behave simply as an optically transparent phase compensator by varying its optical path length mechanically or electrically and coupled with a tuning process. The phase change of laser modes is a result of the cavity mode shift caused by filter optical path change in the tuning process. The phase compensator acts in conjunction with the two cascade etalon filters to compensate any cavity length change and prevent mode hopping.

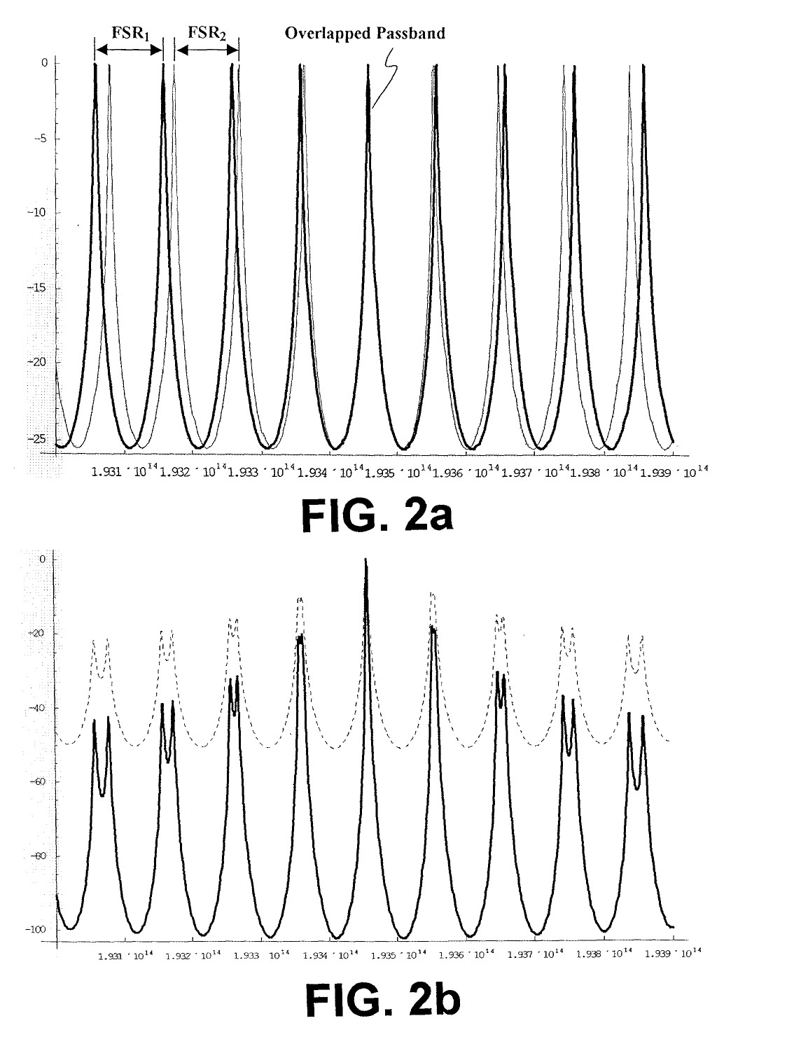

FIG. 2 shows characteristic frequency responses of each Fabry-Perot etalon filter as well as the combined or cascade filters. In FIG. 2a, the thick line and the fine line represent the filter transmission response of the first and the second etalon filter, respectively. Because FSR is different in each filters the narrow transmission passbands are offset with respect to each other such that only one passband from each filter is overlapped over a broad spectral range at the given condition. The cascade filter response is shown in FIG. 2b, where only one passband (the center one in this chart) has 100 percent transmission intensity but all non-overlapped passbands are suppressed. In FIG. 2b, The solid curve represents a transmission response in which the light passes through the cascade filter twice because of the back reflector reflecting light back into the laser amplifier, resulting in a much larger suppression ratio for non-overlapped passbands as opposed to the single-pass case represented by the dashed curve.

The two Fabry-Perot filters can be two individual bulk solid or air-spaced etalons tuned by changing tilting angles. The change of angle can be made with electro-mechanical piezo bender or other actuator. The two Fabry-Perot filters can be made with bulk electro-optical materials, or, made with waveguide electro-optic materials, and tuned by voltages and voltage dependent electro-optic effects. The electro-optical materials can be fused silica glass, liquid crystal, LiNbO3 and other 3 m class materials, and CdTe, GaAs and other 4 m (bar) materials. Furthermore, the etalon filters can be made with thermal materials and by varying filter substrate temperature, etalon filter spacing and refractive index can both be varied to achieve tuning effects. By using electro-mechanical effect, the wavelength switching time is less than 10 msec. The electro-optical tuning mechanism can achieve nanosecond switching between discrete channel of any separation.

The advantage of using intra-cavity cascade Fabry-Perot filters with dissimilar thickness in tuning is that broad overall spectral tuning range can be achieved by small spectral adjustment made on the individual filter. As shown in FIG. 2, FSR1 is 100 GHz and FSR is 95 GHz. It takes only a 5 GHz spectral shift with the second Fabry-Perot filter to realign the overlapped passband from the center passband to its immediately adjacent passband on either side. The net tuning effect is that the absolute wavelength mode is tuned by 100 GHz. As compared with other absolute wavelength tuning means, this tuning method can reduce tuning magnitude by 20 fold, or similarly increase the tuning range by 20 fold for the same tuning conditions.

The operation of the wavelength discretely tunable laser of the invention is now explained. The spontaneous emission light generated by the laser diode is launched onto the cascade Fabry-Perot etalon filters though the collimating lens. The cascade filters select a wavelength mode by passing the wavelength mode through a defined narrow overlapped passband. The selected wavelength mode is reflected by the backside of GRIN lens, passing through the cascade filter a second time for further suppression of unwanted spurious modes, and, coupled back into the active element for amplification. The lasing must occur at one of the cavity longitude modes defined by equivalent cavity length. Any shift of the cavity mode off the selected passband is compensated with the intra-cavity phase compensator. The lasing condition for the selected wavelength is reached when the gain of the selected wavelength mode equals the total cavity loss after certain round trips. Other cavity modes under the non-overlapped transmission peaks formed by cascade filters, are significantly suppressed and not lasing because of strong gain competition dominated by the selected lasing mode. In the cavity, the Fabry-Perot filter is tilted slightly at angle θ1 (θ2) to reduce feedback from the spurious interference and reflections. The tuning is achieved by relatively shifting the transmission passband from each Fabry-Perot filter. Because the gain section and the tuning elements are not coupled in function and tuning process, the output power is not affected by the wavelength tuning and vice versa.

Furthermore, one of the two Fabry-Perot filters is made to have precise transmission passband spacing which meets the International Telecommunications Union DWDM wavelength channel standard grid, i.e., either 100 GHz or 50 GHz. This novel feature makes this filter element work as a built-in wavelength reference inside the tunable laser for standard optical carrier wavelength generation in optical communication networks. Most importantly, since this wavelength reference is a result of the geometric form of the filter and the geometric relationship with the laser diode, the reference filter need not be controlled by any electrical, thermal, chemical, or mechanical means and the reference filter provides a calibration-free function to the tunable laser for applications requiring wavelength generation at the standard grid. No known prior art has achieved this novel intra-cavity wavelength reference function in tunable lasers.

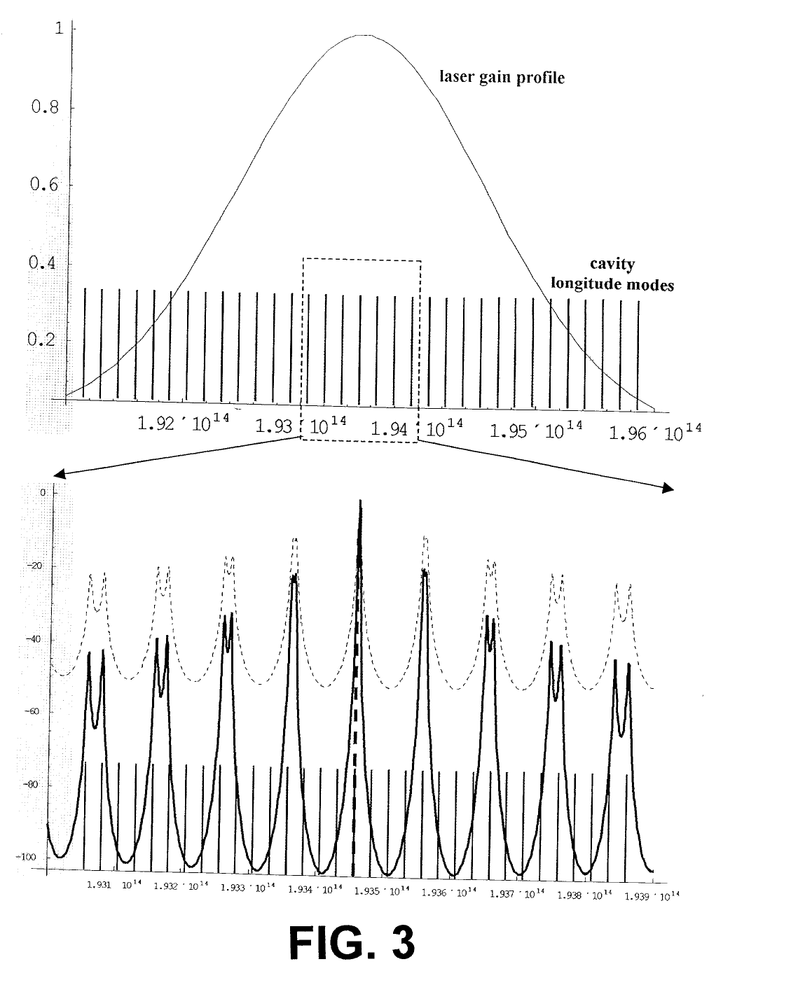

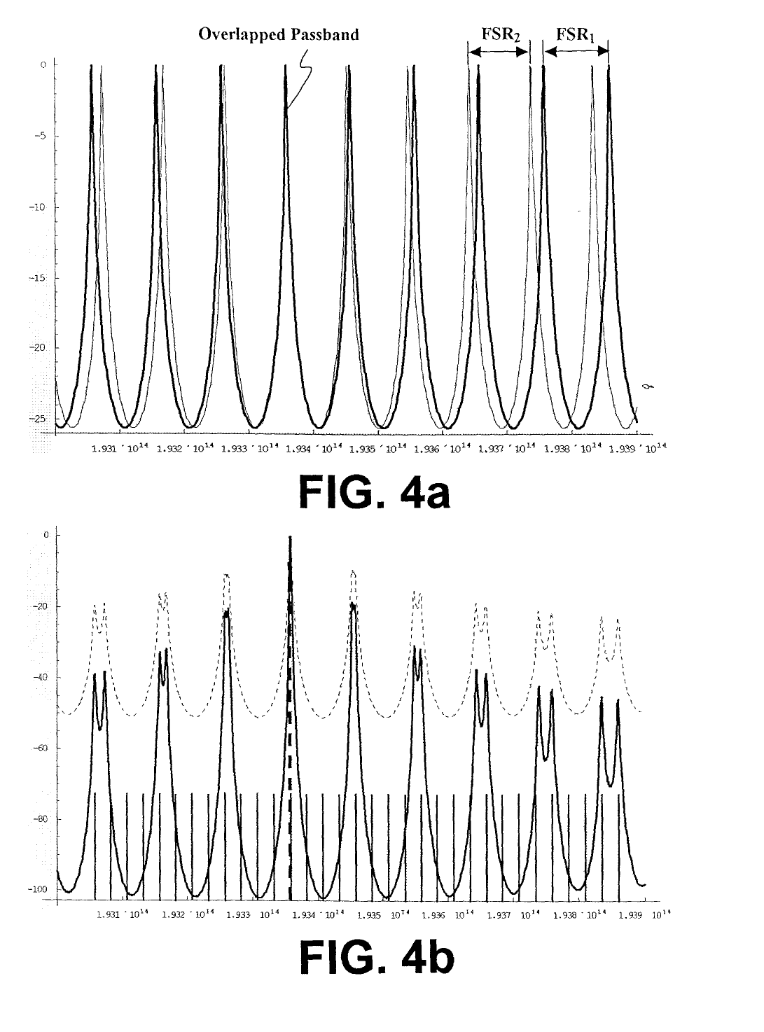

FIG. 3 shows the tuning and lasing mechanism in the current invention. In the upper chart of FIG. 3, underneath the gaussian-shape active gain curve, is a plurality of cavity longitude mode spaced by c/(2 neffL), where neff is the equivalent refractive index of the cavity. The lower part of FIG. 3 is a zoom-in portion of the upper chart as shown by the arrows. In this lower part of FIG. 3, the cascade filter response and cavity longitude modes are overlaid to show the relationship. It demonstrates that the cascade filter passband must align with one of the cavity modes to facilitate the lasing conditions at this wavelength mode. Other modes are suppressed by the non-overlapped passbands. The narrow passband with 1˜3 GHz FWHM is achieved by the combination of high resolution of the individual filter and the double-pass mechanism in the current invention. This assures a single wavelength mode of operation in any specifically tuned spectral position across the entire gain spectral range.

In FIG. 4, the transmission passband from each Fabry-Perot filter was relatively shifted by optical path changes induced by refractive index and physical length variations in one or both filters. The passbands are realigned such that the overlapped passband moves one FSR distance to the left from its original central location. Since the net shift is very small, the required efforts to effect the change are also very small. This demonstrates that it requires only a small optical path change to achieve a large wavelength shift.

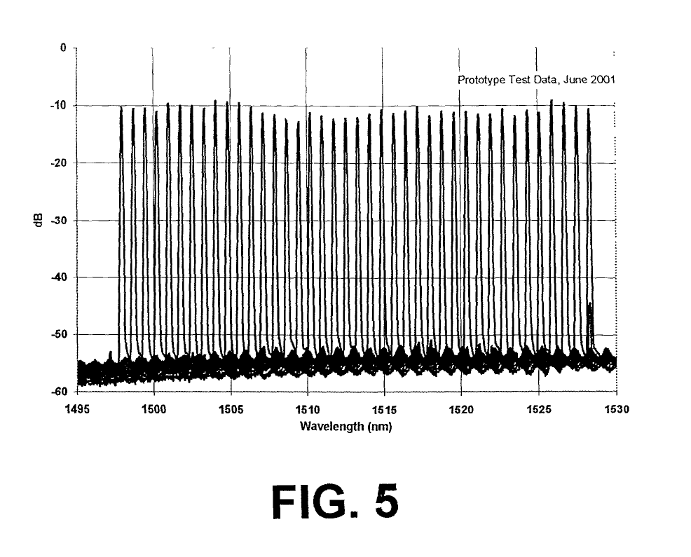

FIG. 5 demonstrates the actual performance of the present invention. The discrete tuning characteristics are shown where each of 41 discrete channels is consecutively or randomly selected, each adjacent channel separated with 100-GHz (0.8 nm at 1550 nm center wavelength) ITU grid. The switching time between wavelengths is less than 10 msec by design of electromechanical tuning mechanism.

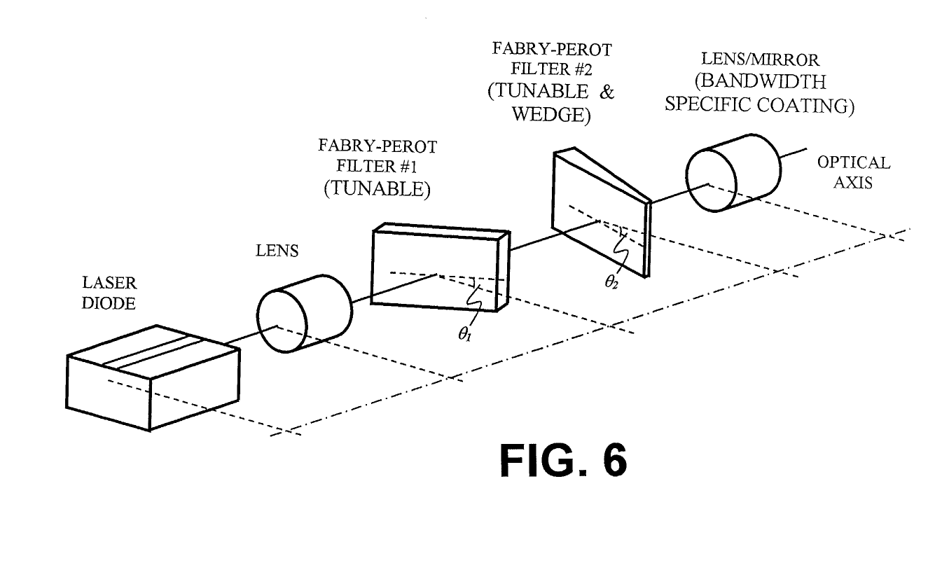

FIG. 6 shows a second embodiment of the tuning element which retains the above discussed features while permitting translational tuning by employing a wedge shape filter in the cascade filter combination. In this embodiment, Fabry-Perot etalon filter No. 2 is replaced by a wedge filter. The filter optical path change and thus the transmission passband shift are achieved by translating the wedge filter in a direction perpendicular to the optical axis. When the wedge filter is translated, the intersection of optical axis with the wedge filter is altered. Thus the optical path in the filter is changed.

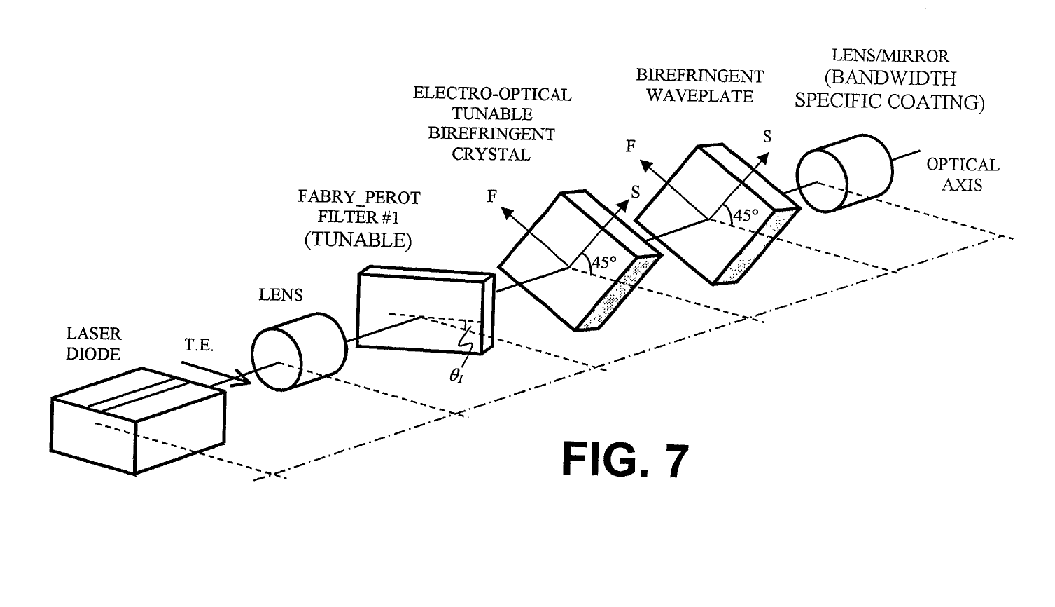

FIG. 7 shows a third embodiment of the inventive tuning structure. In this embodiment, one the two Fabry-Perot filters is replaced by a polarization interference filter. The polarization interference filter consists of an electro-optically-tunable birefringent waveplate, a fixed birefringent waveplate, the laser cavity, and the T.E. polarization light emitted from the laser diode. The slow and fast axes of the waveplates are oriented at 45 degrees with respect to the T.E. polarization of the light emitted from the laser diode. When polarized light passes through the two waveplates, an optical path difference is introduced between the fast and the slow axes. For N round trips, the polarization filter exhibits a repetitive transmission curves expressed by T(v)=(1+cos {4πvD/c})^{N}, where D=D₀ (fixed delay from birefringent plate) +dD (electro-optical delay induced by tunable plate) is the optical delay. The combination of one Fabry-Perot filter and one polarization filter serves as the cascade filter described in the first embodiment of the current invention. The tunable birefringent waveplate can be made of liquid crystal material structure and electro-optical crystal material (such LiNbO3) structures (bulk and waveguide).

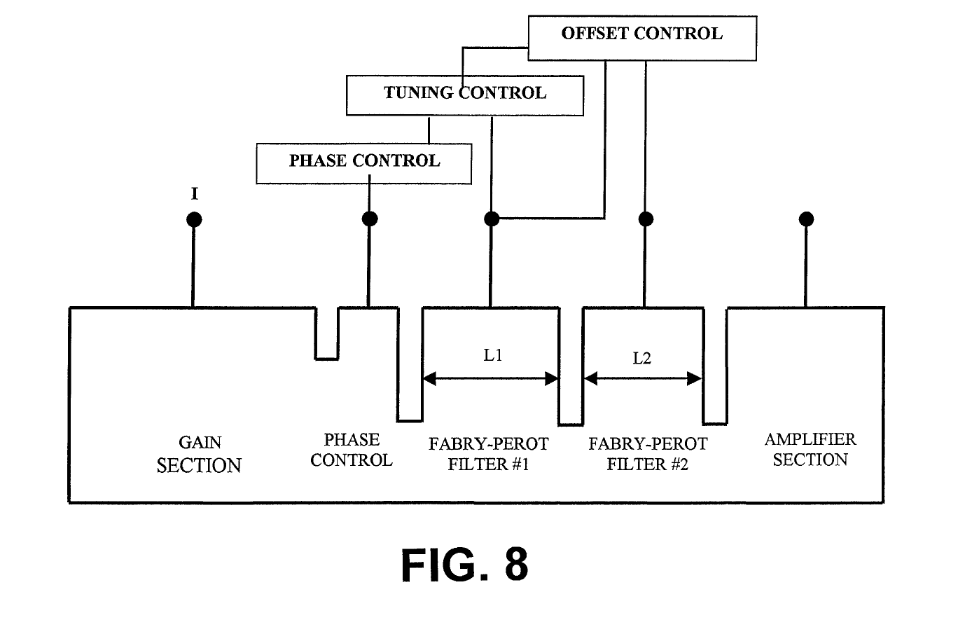

FIG. 8 shows a fourth embodiment of the invention. In this embodiment the laser and wavelength tuning structure are integrated on a semiconductor substrate by epitaxy process while retaining all of the features of the previous embodiments. The facet of the filter is formed by dry or wet etch of the material. The high resolution is enhanced by increasing the Q factor of the section with current injection. The refractive index change, thus the optical path change, is generated by either the voltage or current-dependent electro-refractive effects (linear and non-linear) in semiconductor materials. At one end of the laser, a semiconductor optical amplifier is incorporated to provide amplification to the selected lasing wavelength mode. The control of the tuning is externally determined by electrical circuits which simultaneously balance the cascade filters and cavity length.

While the invention has been disclosed and shown in various embodiments, the scope of the invention is not intended to be, nor should it be, limited thereby and such other modifications or embodiments as may be suggested by the teachings herein are particularly reserved especially as they fall within the breadth and the scope of the claims here appended.

I claim:

1. A wavelength discretely tunable semiconductor laser comprising:
a laser amplifier generating light along a propagation axis;
an end reflector perpendicular to the light propagation axis;
an intracavity first etalon filter having a selected passband spacing;
an intracavity second etalon filter made with slightly different passband spacing from the first etalon, both said first and second etalon filters being positioned along the propagation axis between the laser diode and the end reflector;
a cavity length compensating element between the said second etalon and the end reflector for offsetting etalon tuning induced cavity length changes to eliminate mode hopping.

2. The wavelength discretely tunable semiconductor laser of claim 1, wherein the said first etalon comprises:
standard-compliant pass band separation and intra-cavity wavelength reference; and the frequency of the passband being set by the geometric relation between said laser amplifier and the said first etalon filter; and tuning of said first etalon filter being accomplished by varying at least one of the angle of said first etalon relative to the laser light propagation axis, the etalon refractive index and the etalon spacing.

3. The wavelength discretely tunable semiconductor laser of claim 1, wherein the said second etalon filter comprises:
a passband separation different from the first passband separation of the first etalon and the frequency of the passband being set by the geometric relation between the laser diode and the second etalon filter and being tunable by varying the etalon angle relative to the laser light propagation axis or by varying etalon refractive index or etalon spacing.

4. The wavelength discretely tunable semiconductor laser of claim 1, wherein the said first and second etalon define an overlapped passband with slightly unequal passband spacing to pass a single mode laser amplifier light through the two-etalon compound filter at any given discrete setting of etalon angle, refractive index, or spacing.

5. The wavelength discretely tunable semiconductor laser of claim 1, wherein each said first etalon filter and second etalon filter comprise:
a slab-shaped substrate and refractive layers affixed to the opposite sides of the said slab shaped substrate.

6. The wavelength discretely tunable semiconductor laser of claim 1, wherein each said first etalon filter and second etalon filter comprise:
a slab-shaped substrate including optical transparent electro-optical materials with electric-field dependent refractive index change characteristics to vary etalon cavity optical length.

7. The wavelength discretely tunable semiconductor laser of claim 1, wherein each said first etalon filter and second etalon filter comprise:
a slab-shaped substrate including optical transparent thermal-optical materials with temperature dependent physical length and refractive index change characteristics to vary etalon cavity optical length.

8. The wavelength discretely tunable semiconductor laser of claim 1, further comprising:
an electro-mechanical bending actuator changing the angle of etalon filter relative to the laser light propagation axis.

9. The wavelength discretely tunable semiconductor laser of claim 1, wherein each said first etalon filter and second etalon filter are positioned with tiled angle with respect to light propagation axis and with respect to each other to suppress spurious interference and reflections of the beam.

10. The wavelength discretely tunable semiconductor laser of claim 1, wherein the said first intra-cavity etalon filter provides: the International Telecommunication Union ITU G.692 Standard optical frequency spacing.

11. The wavelength discretely tunable semiconductor laser of claim 1, wherein the said first intra-cavity etalon filter provides standard optical frequency spacing.

12. The wavelength discretely tunable semiconductor laser of claim 1, wherein said second etalon filter comprises:
a polarization interference filter having an electro-optically-tunable birefringent waveplate, a fixed birefringent waveplate, a laser cavity, and T.E. polarization light emitted from the laser amplifier.

13. The wavelength discretely tunable semiconductor laser of claim 1, wherein said second etalon filter comprises:
a wedge-shaped filter positioned so that a filter optical path change and thus a transmission passband shift are achieved by translating the wedge filter in a direction perpendicular to the optical axis.

14. The wavelength discretely tunable semiconductor laser of claim 1, wherein the laser amplifier, the said first etalon filter, the said second etalon filter, the cavity length compensator element and the end reflector are integrated on a semiconductor substrate by epitaxy processes with refractive index change, and an optical path change being generated by either electric-field or current-dependent electro-refractive effects in semiconductor materials.

15. The wavelength discretely tunable semiconductor laser of claim 1, wherein the laser amplifier comprises:
a laser diode with straight gain stripe.

16. The wavelength discretely tunable semiconductor laser of claim 1, wherein the laser amplifier comprises:
a laser diode with angled stripe gain structure.

17. The wavelength discretely tunable semiconductor laser of claim 1, wherein the laser amplifier comprises:
GaAs.

18. The wavelength discretely tunable semiconductor laser of claim 1, wherein the laser amplifier comprises:
AlGaAs.

19. The wavelength discretely tunable semiconductor laser of claim 1, wherein the laser amplifier comprises:
InP.

20. The wavelength discretely tunable semiconductor laser of claim 1, wherein the laser amplifier comprises:
InGaAsP.

21. The wavelength discretely tunable semiconductor laser of claim 1, wherein the laser amplifier comprises:
GaN.

22. The wavelength discretely tunable semiconductor laser of claim 1, further comprising:
a first lens collimating light from said laser amplifier; and
a second lens focusing light on the end of reflector to form a cat's eye structure to stabilize the laser.

23. The wavelength discretely tunable semiconductor laser of claim 22, comprising:
a GRIN lens coated with high reflection material on one side and anti-reflection material on the other side, thereby integrating the end reflector and the second lens.

24. The wavelength discretely tunable semiconductor laser of claim 1, said cavity length compensating element comprising:
a slab shape substrate with anti-reflection coating on its opposite sides and configured as an optically transparent phase compensator by varying its optical path length by at least one of mechanical, electrical and thermal change.

25. The method of discretely tuning wavelength in an optical device including a laser amplifier, two cascade etalon filters, an optical phase compensator, and an end reflector; the method comprising the step of:
changing optical path length of at least one of the said first etalon filter and second etalon filter by varying refractive index and physical length in at least one of said filters to relatively shift and realign the filter transmission passband from each etalon filter such that the overlapped passbands move in steps of FSR across an entire operating wavelength region.
